(19) United States
(12) Patent Application Publication
(10) Pub. No.: US 2017/0017907 A1
(43) Pub. Date: Jan. 19, 2017

(54) SUPPLY CHAIN EXCELLENCE AS A SERVICE

(71) Applicant: Cisco Technology, Inc., San Jose, CA (US)

(72) Inventors: Srikanth Narasimhan, Bangalore (IN); Giridhar Govindarajulu, Bangalore (IN); Ramachandran Krishnamurthy, Bangalore (IN)

(21) Appl. No.: 14/797,939

(22) Filed: Jul. 13, 2015

(51) Int. Cl. G06Q 10/06; H04L 29/06

(52) U.S. Cl. CPC G06Q 10/063; H04L 63/029

(57) ABSTRACT

A hybrid cloud infrastructure and secure tunnels to connect an enterprise cloud with a partner cloud is disclosed. This can permit an enterprise supply chain system to dynamically access a partner supply chain system without the need to wait for asynchronous status updates.

### TECHNICAL FIELD

The present technology pertains to supply chain management, and more specifically pertains to using a hybrid cloud environment to better facilitate data transfer between parties.

### BACKGROUND

Outsourced manufacturing is a method of making products or services in which a first enterprise researches and develops products and then contracts with one or more other enterprises to actually make and deliver the products, or their components or subassemblies. Large business enterprises involved in developing many different products and services have rapidly turned to outsourced manufacturing in recent years as a way to provide flexibility in their operations. For example, if a research enterprise has developed a product and suddenly receives a large increase in orders for the product, the research enterprise can contract with multiple vendors to make and deliver the product, and then discontinue the contracts when order volume decreases. Without outsourced manufacturing, an enterprise is required to manage regular changes in manufacturing capacity, at significant direct and indirect cost to the enterprise.

However, one disadvantage of using outsourced manufacturing is that an enterprise generally must wait for partners to send status updates. These status updates may have inherent delays and fail to provide the level of granularity required for a modern supply chain (e.g., a partner may report that a product is ready to deliver, but will not report on completion of intermediate stages of production).

Conventional techniques utilize business to business (B2B) communications where the enterprise is the communications hub. As the product progresses from raw materials to finished good, it typically passes through various partners. For example, mines might extract the raw materials, transportation partners can then collect the raw materials and deliver them to various manufacturers, the manufacturers can then create various components of the product which are then shipped via more transportation partners to assemblers, other transportation partners then can take the finished good to various retail outlets. As a product moves down the supply chain, the enterprise traditionally coordinates information between partners. For example, in reaction to receiving a B2B message that one partner has completed its stage of production, the enterprise will send a B2B message to the downstream partner that the product is ready for their stage of production. Sending and receiving these messages can create unnecessary delays, from a few minutes to hours or even days.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example hybrid cloud architecture;

FIG. 1B illustrates an example of migrating a virtual machine in a hybrid cloud architecture;

FIG. 1C illustrates an example hybrid cloud wherein one private cloud is in communication with multiple public clouds;

FIG. 2 illustrates an example configuration of devices and a network;

FIG. 3A, 3B, and 3C illustrate example configurations with an enterprise and multiple partners;

FIG. 4 illustrates various partner progress scenarios;

FIG. 5 illustrates progress of a nested supply chain; and

FIG. 6A and FIG. 6B illustrate example system embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for real-time visibility of inventory progression through an enterprise's supply chain.

### Overview

Many enterprises do not produce their products entirely “in-house,” they typically outsource to partners to perform various steps in the production process. A supply chain is a network of these partners that procure raw materials, transform them into intermediate subassemblies and final products, and then deliver the products to customers through a distribution system. A global supply chain process has an eco-system of multiple partners and many nodes. Partners can be logistics partners, shipping partners, manufacturing partners, resource gathering partners, retail partners, wholesale partners, marketing partners, legal partners, etc. Data exchange, communication, and collaboration across this ecosystem are vital.

Current communication techniques involve partners connecting to an enterprise through a business-to-business (B2B) cloud. All data travels from the enterprise private cloud through the B2B cloud and then to partners and supply chain nodes. This arrangement entails multiple hops and contributes to data latency. The operational efficiency and performance of a supply chain is fettered by the lack of real-time, multi-tier visibility and is compounded by limited workload portability and data latency.

The principles disclosed herein enable an entity in a supply chain (i.e., the enterprise and its partners) to access data from the other entities in the supply chain. For example, an enterprise can access a partner's data, a partner can access the enterprise's data, or a partner can access another partner's data. The data can comprise raw data, summary data, or a combination of the two. Summary data can include that a partner has completed its assignment in the supply chain and an item is ready for transfer to the next partner. Summary data can comprise an estimation of when the assignment will be complete, an estimation of the percentage complete of the assignment, an expected start date for the assignment, etc.

Instead of waiting for one entity to volunteer or send asynchronous communications in curated reports or summaries, an entity can access, synchronously, raw data from another entity. For example, raw data can comprise assembly line status updates, personnel reports, product scans, invoices, tracking data, supply counts, excess capacity, vacation schedule, live camera streams, machine status reports, inventory counts, etc. Raw data can also include historical data. In some embodiments, confidential information is removed from raw data. Raw data can comprise the inputs and reports that a partner may use to create summary data

With increased granularity of data regarding segments of the supply chain, the enterprise can make decisions that will increase the efficiency of the supply chain. For example, the enterprise can detect that one partner is ahead of or behind schedule and inform the downstream supply chain partners that they should expect an earlier or later transaction. Similarly, partners can gather data from upstream and downstream partners and plan accordingly. For example, an assembly partner can determine that a shipping partner is ahead of schedule and can, in response, be prepared to receive the good earlier. If an upstream partner determines that a downstream partner is experiencing delays and will not be able to accommodate the transaction on schedule, the upstream partner can reprioritize their operations accordingly.

In some embodiments, the increased visibility can serve as authorization for transactions between partners. For example, an upstream partner can detect that a downstream partner is authorized to handle a good or package of goods and the upstream partner can use that information as authorization to deliver the goods to the downstream partner.

The principles disclosed herein can be performed using a hybrid cloud solution that provides real-time visibility into data and inventory movement. The enterprise's security, consistency, and policy requirements can be maintained across the ecosystem. With this information, partners can make delivery, demand, and customer service decisions faster, in real time, and across the entire supply chain ecosystem.

### DETAILED DESCRIPTION

A “hybrid cloud” is a cloud infrastructure composed of two or more clouds that inter-operate or federate through technology. In essence, a hybrid cloud is an interaction between private and public clouds where a private cloud joins a public cloud and utilizes public cloud resources in a secure and scalable way. The hybrid cloud model provides the key advantages over other cloud models, such as by allowing enterprises to protect their existing investment, and maintain control of their sensitive data and applications, as well as their network, computing, and storage resources. In addition, hybrid clouds allow enterprises to readily scale their environment on demand. A significant advantage of a hybrid cloud is the capability to dynamically “migrate” resources between the private cloud and the public cloud; therefore it should be understood that the depiction of a resource on either cloud is not a limitation but an example placement unless explicitly described as a limitation.

A significant advantage of the “cloud” infrastructure is the ability to interoperate “virtual” resources with “bare-metal” resources. As such, many virtual resources can provide the same functionality as bare-metal resources and vice versa. Therefore, it should be understood that any depiction of a resource being a “virtual machine” or bare-metal is for purposes of illustration and not limitation.

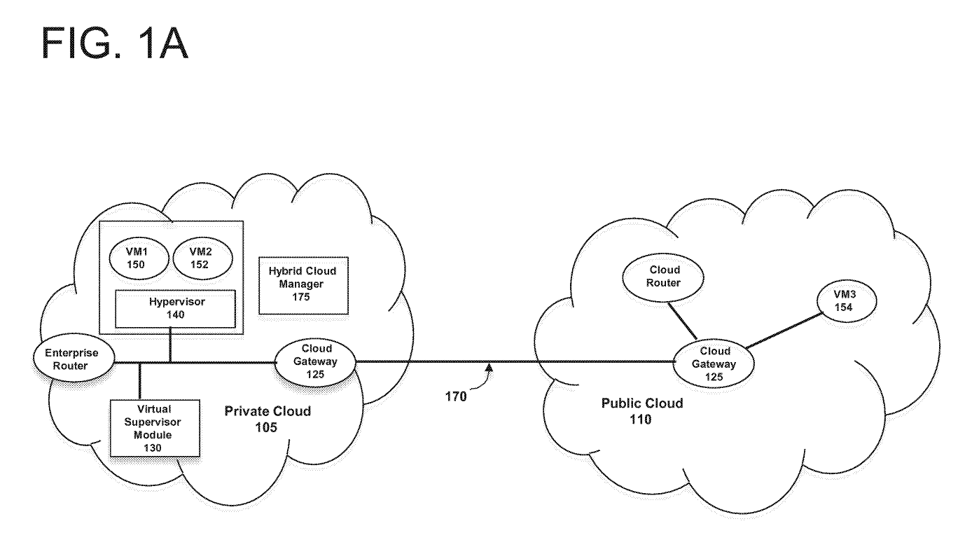

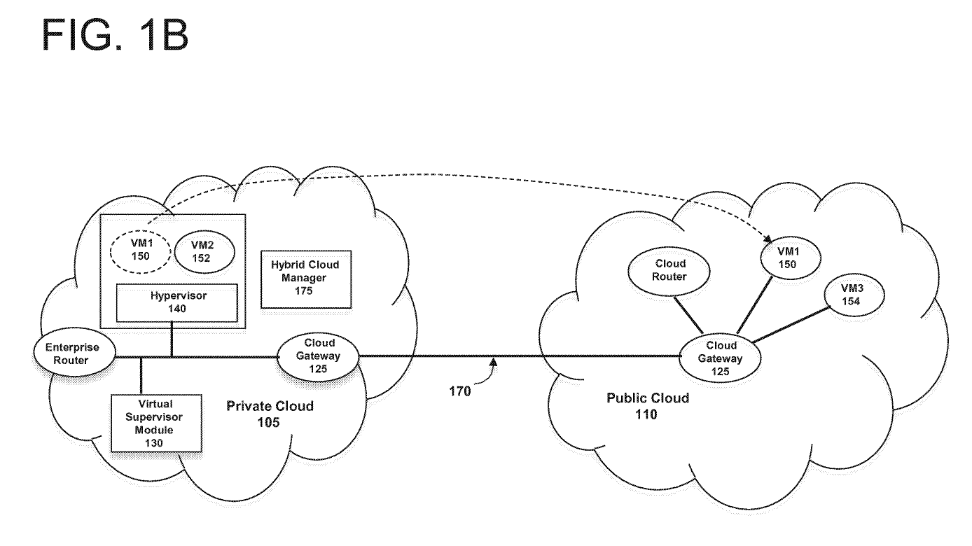

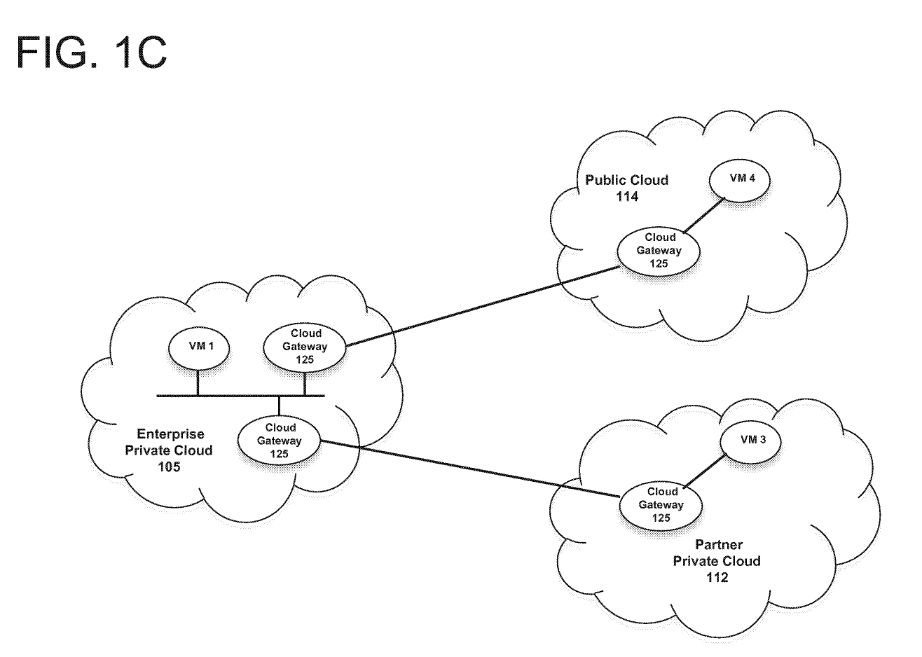

FIG. 1A illustrates an example hybrid cloud network illustratively comprising a plurality of networks or “clouds,” including a private cloud 105 (e.g., enterprise datacenters) and a public cloud 110 separated by a public network, such as the Internet (not shown). Although current terminology refers to a hybrid cloud comprising a private cloud and a public cloud, it should be understood that many aspects of this disclosure can be practiced in various multi-cloud configurations (e.g., two clouds hosted by third party providers or two enterprise clouds located in different locations). The private cloud 105 and public cloud 110 can be connected via a communication link 170 between cloud gateway 125 and cloud gateway 135. Data packets and traffic can be exchanged among the devices of the hybrid cloud network using predefined network communication protocols as will be understood by those skilled in the art.

As depicted in FIG. 1A, each cloud network element can have a cloud gateway 125 at the private cloud 105, a cloud gateway 135 at the public cloud 110, and at least one virtual machine (VM). For example, FIG. 1A illustrates VM1 150, VM2 152, at the private cloud 105, and VM3 154 (or nested VM containers) within the public cloud. The cloud gateway 125 at the private cloud can be configured as a VM running in the private cloud (enterprise datacenter) that is responsible to establish a communication link 170 for interconnecting the components in the public cloud with the private cloud. The cloud gateway 135 at the public cloud may be configured as a VM running in the public cloud that is responsible to establish the communication link 170 for connecting the cloud gateway 135 with cloud resources.

FIG. 1A also illustrates a hybrid cloud manager 175 within the private cloud 105 which can be a management plane VM for auto-provisioning resources within the hybrid cloud solution. Specifically, the hybrid cloud manager 175 is a management platform (which could be a VM) running in the private network, and may be generally responsible for providing the hybrid cloud operations, translating between private cloud and public cloud interfaces, management of cloud resources, dynamic instantiating of cloud gateways and cloud VMs components (VM3 154 in the public cloud 110) though the private virtualization platform and public cloud provider APIs. It may also health-monitor all the components (e.g., the cloud gateways, the one or more private application VMs, and the communication link 170 and provides high availability of those components.

FIG. 1A also illustrates a virtual supervisor module 130 (for example, the Nexus 1000V Switch by Cisco Systems, Inc.), a hypervisor 140 (also called a virtual machine manager) and one or more VM 150, 152. The virtual supervisor module 130 in the private cloud can be used to create VMs in the public or private cloud, such as VM1 150, VM2 152, and VM3 154. Each VM hosts a private application, even VM3 154 in the public cloud hosts a private application, and it is as though VM3 154 in the public cloud were within the private cloud. The hypervisor 140 can be configured by the virtual supervisor model 130, and provides an operating system for one or more VMs.

As introduced above, FIG. 1A also illustrates communication link 170. Communication link can take several forms include a type of VPN, or a tunnel. Specifically, some hybrid cloud technologies utilize an open virtual private network (VPN) overlay or else an IP security (IPSec) VPN based L3 network extension to provide communication link 170. While offering secure transport connections in a cloud environment, VPN does not provide a switch infrastructure for providing features such as switching network traffic locally at the cloud, providing consistent enterprise network polices, allowing insertion of various network services (e.g., load balancers, firewalls, etc.), and construction of a sophisticated network topology (e.g., the current systems are connected through a router and multiple VLANs). While IPsec-VPN-based technology can provide customers inter-datacenter network connectivity and relatively sophisticated network topologies, it can only extend the enterprise network at the network layer (Layer 3 or “L3” of the illustrative and well-known OSI model). This implies that the overlay networks created at the cloud datacenter (public cloud 110) must be a set of new subnets, where VMs in the public cloud are assigned with new network identities (e.g., IP and MAC addresses). Because of this, many of enterprise infrastructures (e.g., access control lists, firewall policies, domain name services, etc.) must be modified in order for the newly attached VM systems to be able to work with rest of the enterprise systems. Even the IPSec VPN tunnel would cause problems in penetration of corporate firewalls and Network Address Translation (NAT) devices deep within the enterprise datacenter (private cloud 105).

Some hybrid cloud technologies, such as the presently described technology, utilize a secure transport layer (e.g., Layer 4 or “L4”) tunnel as the communication link 170 between a first cloud gateway 125 in a private cloud 105 and a second cloud gateway 135 in a public cloud 110, where the secure transport layer tunnel is configured to provide a link layer (e.g., Layer 2 or “L2”) network extension between the private cloud and the public cloud. By establishing a secure transport layer (L4) tunnel 370 (e.g., transport layer security (TLS), datagram TLS (DTLS), secure socket layer (SSL), etc.) over the public network 115, the techniques herein build a secure L2 switch overlay that interconnects cloud resources (public cloud 110) with private clouds 105 (e.g., enterprise network backbones). In other words, the secure transport layer tunnel 370 provides a link layer network extension between the private cloud and the public cloud.

As noted, the cloud gateway 125 deployed at the private cloud 105 can use an L4 Secure Tunnel to connect to the cloud resources allocated at public cloud 110. The L4 secure tunnel is well-suited for use with corporate firewalls and NAT devices due to the nature of the transport level protocols (e.g., UDP/TCP) and the transport layer ports opened for HTTP/HTTPS in the firewall. The L2 network is thus further extended and connected to each of the cloud VMs, e.g., VM1 150, VM2 152, VM3 154 through the cloud gateway 135 deployed at the public cloud 110. With an L2 network overlay, all instances of a particular private application VM, e.g, VM3 154 can be seamlessly migrated to the overlay network dynamically created at the public cloud, without any impacts to the existing corporate infrastructure.

As a general practice, a public cloud service provider offers only a limited number of network attachments for each of the cloud VMs, e.g., VM3 154, and network broadcasting capability. This prohibits enterprise customers when migrating their multi-VLAN network architectural environment into the public cloud datacenter. However, building an L2 network overlay on top of L4 tunnels as described herein reduces the network attachments requirements for cloud VMs and provides cloud VMs with network broadcasting ability. The techniques herein thus allow enterprise customers to deploy consistent enterprise-wide network architectures, even in a hybrid cloud environment.

FIG. 1B illustrates a hybrid cloud environment as illustrated in FIG. 1A being used to migrate a VM from private cloud 105 to public cloud 110. Perhaps a VM on the private cloud needs to be scaled beyond the current resources of the private cloud, or perhaps the private cloud needs to be taken off line for a period of time. In either situation it can be desirable to migrate an application on the private cloud to the public cloud. FIG. 1B illustrates VM1 150 on private cloud 105 being migrated to public cloud 110, where it is illustrated as VM1 150₁. Migration is managed using virtual supervisor module 130 to take VM1 150 offline, and migrated using hybrid cloud manager 175 to copy the VM1 150 disk image to public cloud 110, and instantiate it in the public cloud.

FIG. 1C illustrates an example hybrid cloud environment. In FIG. 1C, a public cloud 114 is running an application or service in VM4 156. The application is shared by the enterprise private cloud 105 and partner private cloud 112. In such hybrid cloud environments a public cloud can act as an intermediary that provides limited access to the enterprise and the partner.

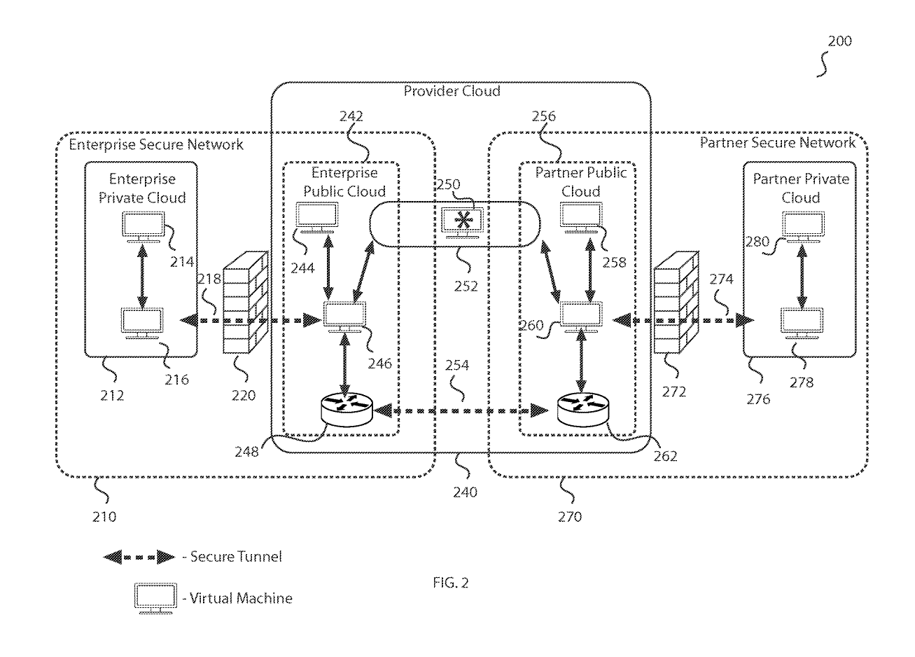

FIG. 2 depicts an example embodiment of this disclosure comprising enterprise private cloud 212, partner private cloud 278, and provider cloud 240. Provider cloud 240 can host enterprise public cloud 242 which can be connected to enterprise private cloud 212 via secure tunnel 218 and partner public cloud 256 which can be connected to partner private cloud 276 via secure tunnel 274.

On enterprise private cloud 212, enterprise supply chain system 214 can contain supply chain data for the enterprise, such as product planning, costs, inventory control, marketing, etc. For example, enterprise supply chain system 214 can be an enterprise resource planning (ERP) software package. Enterprise supply chain system 214 can be connected to enterprise intercloud extender 216 which can maintain secure tunnel 220 to enterprise intercloud switch 246. Secure tunnel 220 can exit enterprise private cloud 212, pass through enterprise firewall 220, and arrive at enterprise public cloud 242 (which resides on provider cloud 240). Data that is passed through devices on enterprise secure network 210 can be securely maintained within enterprise secure network 210 according to governing policies.

Similarly, on partner private cloud 276, partner supply chain system 280 can contain supply chain data for the partner, such as product planning, costs, inventory control, marketing, etc. For example, partner supply chain system 280 can be an enterprise resource planning (ERP) software package. Partner supply chain system 280 can be connected to partner intercloud extender 278 which can maintain secure tunnel 274 to partner intercloud switch 262. Secure tunnel 274 can exit partner private cloud 276, pass through partner firewall 272, and arrive at partner public cloud 256 (which resides on provider cloud 240). Data that is passed through devices on partner secure network 270 can be securely maintained within enterprise secure network 270 according to governing policies.

Enterprise intercloud fabric router 248 and partner intercloud fabric router 262 can service a secure virtual private network (VPN) tunnel 254 between enterprise public cloud 242 and partner public cloud 256. Enterprise intercloud fabric router 248 can be connected to enterprise intercloud switch 246 and partner intercloud fabric router 248 can be connected to partner intercloud switch 260.

Thus configured, enterprise supply chain system 214 can have a data link to partner supply chain system 280. This data link can comprise enterprise intercloud extender 216, enterprise intercloud switch 246, enterprise intercloud fabric router 248, partner fabric router 248, garter intercloud switch 260, and partner intercloud extender 278.

In some embodiments, virtual machines 244 and 258 can reside on enterprise public cloud 242 and partner public cloud 256, respectively. Virtual machines 244 and 258 can replicate some functionality and data contained on their respective private clouds. For example, virtual machine 258 can mirror the event data collected by partner supply chain system 280.

Because enterprise private cloud 212 and partner private cloud 276 might be geographically isolated, a traditional internet connection between the two entities might be slower than desired. Provider cloud 240 can help overcome this problem by having nodes and connection points (“edge nodes”) around the world that are connected by high-speed dedicated lines. The link between enterprise private cloud 212 and partner private cloud 276 can then leverage the backbone of provider cloud for faster access speeds. It should be understood that although there are many advantages to having enterprise public cloud 242 and partner public cloud 256 hosted on same provider cloud 240, such a configuration is not necessary. For example, enterprise public cloud 242 can be hosted on one provider cloud while partner public cloud 256 can be hosted on another.

In some embodiments, data management hub 250 is connected to enterprise intercloud switch 246 and partner intercloud switch 260 by means of shared space 252. Shared space 252 can be created using secure tunnels to parties' public clouds. Shared space 252 can also be created by granting enterprise public cloud 242 and partner public cloud 256 access to data management hub 250 as though it was a local virtual machine provisioned on their respective public clouds. In some embodiments, data management hub 250 collects and redistributes B2B messages from enterprise supply chain system 214 and partner supply chain system 280. In some embodiments, data management hub 250 replicates a database stored on enterprise supply chain system 214 and partner supply chain system 280. In some embodiments, data management hub 250 reduces the necessity of secure tunnel 254.

In some embodiments, data management hub 250 does not store and redistribute supply chain data; rather data management hub 250 coordinates access between parties. For example, enterprise supply chain system 214 can request data access of partner supply chain system 280 from data management hub 250. Data management hub 250 can validate and forward the request to partner supply chain system 280 which can respond with an access token that can be forwarded on to enterprise supply chain system 214. Data management hub 250 can provide the necessary configuration information to establish secure connection 254 between intercloud fabric routers 248 and 262. Enterprise supply chain system 214 can then connect directly to partner supply chain system 280 through secure tunnels 218, 254, and 274.

In some embodiments, data management hub 250 is a virtual machine that resides exclusively on one public cloud (e.g., enterprise public cloud 242 or partner public cloud 256). Data management hub 250 can perform its functions herein disclosed by connecting to services external to its network via secure tunnel 254.

Although data management hub 250 can provide many meaningful functions, it is not always necessary to practice all principles disclosed herein. For example, secure connections 218, 254, and 274 combined with firewalls 220 and 272 can ensure that only appropriate data is communicated between enterprise secure network 210 and partner secure network 270.

FIGS. 2A, 2B, and 2C depict example embodiments, highlighting various connection configurations of multiple entities. In each of FIGS. 2A, 2B, and 2C, enterprise private cloud is connected to enterprise public cloud 242 via secure tunnel 218; similarly, partner A private cloud 304 is connected to partner A public cloud 310 via secure tunnel 306 and partner B private cloud 302 is connected to partner B public cloud 312 via secure tunnel 308. Enterprise public cloud 242, partner A public cloud 310, and partner B public cloud 312 can be hosted on the same provider network 240 as depicted or on distinct provider networks. Secure tunnels 218, 306, 308, 321, 322, and 323 can be expansive in scope (granting access to the entirety of an entity's network resources) or limited (only granting access to a small collection of an entity's network resources).

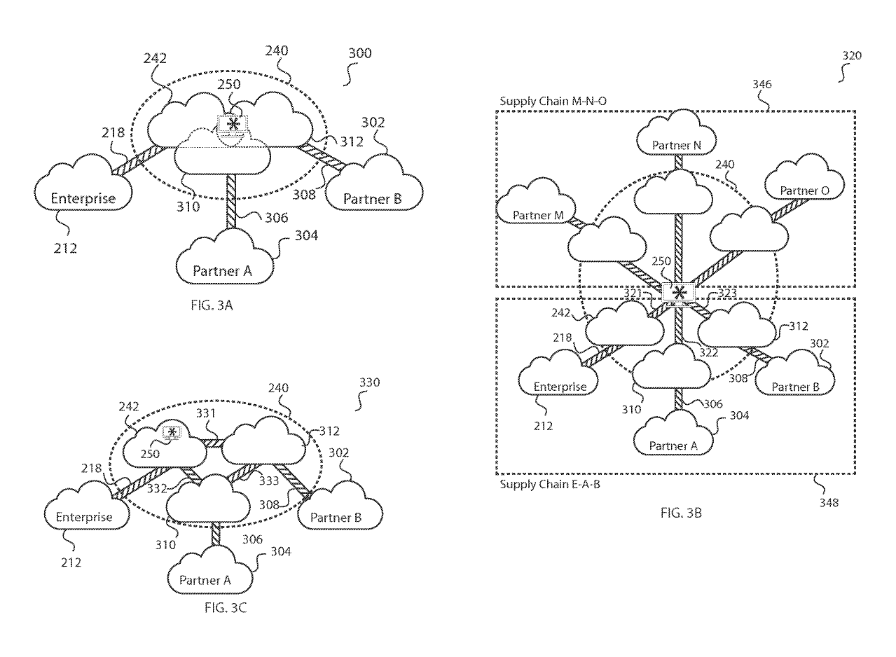

FIG. 3A depicts an example embodiment 300 wherein enterprise public cloud 242, partner A public cloud 310, and partner B public cloud 312 overlap in part. This overlapping is representative of data management hub 250 being directly accessible and visible on each public cloud. For example, enterprise public cloud 242 can send and receive data securely and directly with data management hub 250 as if it were a cloud resource provisioned on enterprise public cloud 242. One advantage to this system is simplicity and redundancy. For example, if a resource goes offline or experiences significant slow-downs, data management hub can still service updates and requests for the other parties. Data management hub 250 can mirror databases and virtual machines stored on the various parties' private clouds.

FIG. 3B depicts an example embodiment 320 wherein enterprise public cloud 242, partner A public cloud 310, and partner B public cloud 312 each maintain a secure tunnel (321,322, and 323, respectively) to data management hub 250. In FIG. 3B, the Enterprise clouds (112 and 142), Partner A clouds (304 and 310), and Partner B clouds (302 and 312) comprise Supply Chain E-A-B 348 while Partner M, Partner N, and Partner O clouds comprise Supply chain M-N-O 346. In this configuration, data management hub 250 is the broker of information between entities and is a single point of configuration for the transactions. Data management hub 250 can manage multiple supply chain operations and does not need to be provisioned specific to a supply chain. For example, data management hub 250 can manage Supply Chain E-A-B 348 while simultaneously managing Supply Chain M-N-O that corresponds with a completely distinct enterprise. Alternatively, data management hub 250 can be instantiated for each supply chain. For example, is the data management hub that manages Supply Chain E-A-B experiences failure, the data management hub that manages Supply Chain M-N-O will be unaffected.

FIG. 3C depicts an example embodiment 330 wherein enterprise public cloud 242, partner A public cloud 310, and partner B public cloud 312 are interconnected through secure tunnels 332, 331, and 333. In some embodiments, enterprise coordinates secure tunnel 333 between partner A public cloud 310 and partner B public cloud 312. In some such embodiments, data management hub 250 can be located on enterprise public cloud 242 and accomplishes the intercloud coordination. Alternatively, partner A and partner B can coordinate secure tunnel 333 without supervision from enterprise. For example, partner A and partner B can compare their purchaser lists and establish a secure tunnel and grant access to data relevant to the common purchasers.

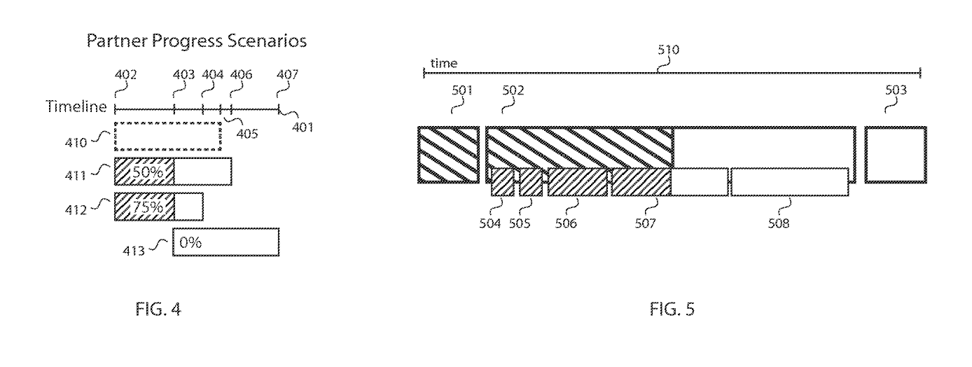

FIG. 4 depicts example possible partner progress scenarios. Timeline 401 goes from project start 402 to various expected completion times 404-407 and defines current time 403. Bar 410 represents an initially quoted length of time starting at time 402 and completing at time 405. Bars 411, 412 and 413 represent different partner progress scenarios as observed at time 403. For example, scenario 411 has the partner starting on-time (time 402), but has only completed 50% of its assignment; enterprise can then determine an estimate that the partner will complete the assignment late, at time 406. In scenario 412, the partner has completed 75% of the assignment by time 403, which results in an early estimated completion time at time 404. In scenario 413, the partner has not completed any percentage of the assignment due to a delay; if the partner starts at time 403 then the partner can be expected to complete by 407. In each of these scenarios 411, 412, and 413, enterprise can determine what percentage of the assignment is completed and determine an estimated time of completion based on the raw data from the partner. It should be understood that the enterprise could also rely on the partner's determinations and expectations. In some embodiments, enterprise relies on some of partner's determinations while disregarding others (for example, the enterprise may rely on the partner's determination of percentage complete but formulate its own expected completion time).

As depicted in FIG. 5, the principles disclosed herein can be applied to situations involving a nested supply chain. For example, enterprise can contract partner A to complete assignment 501, partner B to complete assignment 502, and partner C to complete assignment 503. Partner B might subcontract to sub-partners B1-B5 to complete sub-assignments 504-508 which make up assignment 502. Assignment 501 and sub-assignments 504-506 are complete, while assignment 502 and sub assignment 507 are partially complete, and assignment 503 and sub-assignment 508 have not begun. The enterprise can use data from partner B to determine the progress of assignment 502. The data from partner B can include summary data from sub-partners B1-B5, for example, expected completion dates, current status, etc. The data from partner B can include raw data from partners B1-B5, for example, location of component items in assembly or manufacturing process. The data from partner B can include configuration and connection information which can enable a secure connection between enterprise and sub-partners B1-B5, thus enabling enterprise to connect enterprise public cloud 242 with (sub-) partner public cloud 256.

In some embodiments, the enterprise is a media delivery company (e.g., a cable company, radio station, online music or video streaming service, stock photo repository, newspaper, library, video game publisher, etc.). In some such embodiments, the partner can be a media producer (e.g., musician, videographer, writer, reporter, etc.). Instead of waiting for curated status reports from the partner, the enterprise can access real-time updates on the current state of a project or product. For example, a streaming service (the enterprise) can, for an upcoming film it will offer, determine that a storyboard is written and that three of five days of filming are complete.

In some embodiments, the enterprise is an online video streaming company. In some such embodiments, the enterprise facilitates content creators uploading their content to the enterprise. Using the principles disclosed herein, the enterprise can determine the progress of the content and automatically make the content available online when it is completed.

In some embodiments, the enterprise is a media creation company which outsources various aspects of creation. For example, the enterprise can be a movie studio and the partners comprise writers, storyboard teams, special effects teams, artists, publicity teams, etc. The enterprise can then determine how far along each partner is and determine if unanticipated delays are forthcoming.

In some embodiments, the enterprise can use this data to determine an estimated time to completion. If the enterprise anticipates an unplanned delay, the enterprise can take remedial action like hiring extra partners to expedite a portion of the supply chain.

In some embodiments, enterprise can provide an end customer with added insights as to the development of a product while it travels through the supply chain. For example, if end customer purchased a car from enterprise, end customer can be provided tracking data of all of the parts, biographies of the workers who took part in the supply chain process, video streams of the car being assembled and painted, and a dynamic estimated delivery date.

In some embodiments, enterprise can use partner data to measure, enforce, and validate certain protocols or certifications. For example, an enterprise can certify that its product is “conflict free” (i.e., does not use suppliers that are funding warring states), that its product meets environmental certifications (each partner utilizes environmentally friendly procedures), or governmental mandates (that a certain percentage of products are sourced locally, that trade restrictions are followed, etc.).

### Example Devices

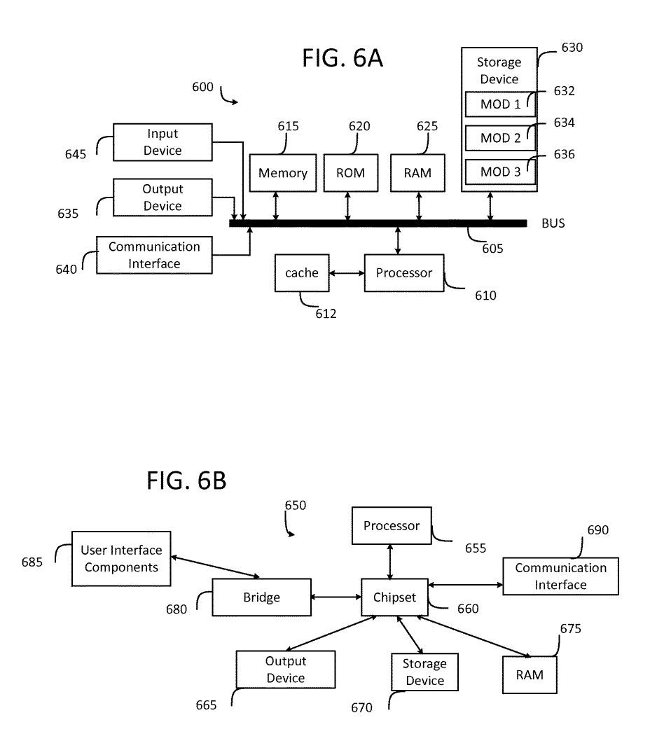

FIG. 6A and FIG. 6B illustrate example system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 670 and random access memory (RAM) 675, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 637, module 7 634, and module 3 636 stored in storage device 630, configured to control the processor 910 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 675, read only memory (ROM) 670, and hybrids thereof.

The storage device 630 can include software modules 637, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates an example computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that example systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

1. A system for supply chain monitoring comprising:
a first enterprise virtual machine instance executing in an enterprise private cloud, the first enterprise virtual machine instance being configured to monitor supply chain partners;
a second enterprise virtual machine instance executing in an enterprise public cloud, the enterprise private cloud and the enterprise public cloud being linked by a first secure tunnel, the first enterprise virtual machine and the second enterprise virtual machine being in communication via the first secure tunnel;
a second partner's first virtual machine instance executing in a first partner's private cloud, the first partner's first virtual machine being configured to track the status of a portion of the supply chain for which the first partner is responsible;
a first partner's second virtual machine instance executing in a first partner's public cloud, the first partner's private cloud and the first partner's public cloud being linked by a second secure tunnel, the first partner's first virtual machine and the first partner's second virtual machine being in communication via the second secure tunnel; and
the second enterprise virtual machine instance and the first partner's second virtual machine instance being linked be a third secure tunnel and the second enterprise virtual machine and the second partner virtual machine being in communication via the third secure tunnel, whereby data regarding the status of the portion of the supply chain for which the first partner is responsible is transmitted to the second enterprise virtual machine.

2. The system of claim 1, further comprising a data management hub virtual machine instance executing on the enterprise public cloud configured to establish and maintain the third secure tunnel.

3. The system of claim 1, wherein the enterprise public cloud and the first partner's public cloud are hosted on the same provider public cloud.

4. The system of claim 3, further comprising a data management hub virtual machine instance executing on the provider public cloud configured to establish and maintain the third secure tunnel.

5. The system of claim 1, wherein data regarding the status of other portions of the supply chain for which the first partner is not responsible is transmitted to the first partner's second virtual machine.

6. The system of claim 1, wherein the enterprise sells digital media and wherein the first partner is a digital media creator.

7. The system of claim 1, further comprising:
a second partner's first virtual machine instance executing in a second partner's private cloud, the second partner's first virtual machine being configured to track status of a portion of the supply chain for which the second partner is responsible;
a second partner's second virtual machine instance executing in a second partner's public cloud, the second partner's private cloud and the second partner's public cloud being linked by a fourth secure tunnel, the second partner's first virtual machine and the second partner's second virtual machine being in communication via the fourth secure tunnel; and
the second enterprise virtual machine instance and the second partner's second virtual machine instance being linked be a fifth secure tunnel and the second enterprise virtual machine and the second partner's second virtual machine being in communication via the fifth secure tunnel, whereby data regarding the status of the portion of the supply chain for which the second partner is responsible is transmitted to the second enterprise virtual machine.

8. The system of claim 7, further comprising a data management hub virtual machine instance executing on the enterprise public cloud configured to establish and maintain the third secure tunnel and the fourth secure tunnel.

9. The system of claim 8, wherein the data management hub virtual machine instance executing on the enterprise public cloud is configured to establish and maintain a sixth secure tunnel between the first partner's second virtual machine and the second partner's second virtual machine, the first partner's second virtual machine and the second partner's second virtual machine being in communication via the sixth secure tunnel, whereby data regarding the status of the portion of the supply chain for which the second partner is responsible is transmitted to the first partner's second virtual machine.

10. A method for supply chain monitoring comprising:
establishing a first secure tunnel between an enterprise private cloud and an enterprise public cloud, wherein a first enterprise virtual machine instance located on the enterprise private cloud and a second enterprise virtual machine instance located on the enterprise public cloud are in communication via the first secure tunnel, and wherein the first enterprise virtual machine instance is configured to monitor supply chain partners;
establishing a third secure tunnel between the enterprise public cloud and a first partner's public cloud, wherein the second enterprise virtual machine instance located on the enterprise public cloud is in communication with a first partner's second virtual machine instance located on the first partner's public cloud via the third secure tunnel, and wherein:
the first partner's second virtual machine instance is in communication with a first partner's first virtual machine instance located on a first partner's private cloud via a second secure tunnel; and
the first partner's first virtual machine instance is configured to track status of a portion of the supply chain for which the first partner is responsible; and
receiving, by the second enterprise virtual machine instance, data regarding the status of the portion of the supply chain for which the first partner is responsible.

11. The method of claim 10, further comprising receiving configuration data from a data management hub virtual machine instance that is in communication with the second enterprise virtual machine instance, wherein the creating of the second secure tunnel uses the configuration data.

12. The method of claim 10, further comprising transmitting, from the second enterprise virtual machine instance to the first partner's second virtual machine instance, data regarding the status of other portions of the supply chain for which the first partner is not responsible to the first partner's second virtual machine instance.

13. The method of claim 10, wherein the enterprise sells digital media and wherein the first partner is a digital media creator.

14. The method of claim 8, further comprising calculating, using the data regarding the status of the portion of the supply chain, a calculated completion date for the partner's portion of the supply chain.

15. The method of claim 14, further comprising, determining that the supply chain is delayed and notifying a second partner of a change in the supply chain schedule.

16. The method of claim 10, further comprising:
establishing a fifth secure tunnel between the enterprise public cloud and a second partner's public cloud, wherein the second enterprise virtual machine instance located on the enterprise public cloud is in communication with a second partner's second virtual machine instance located on the second partner's public cloud via the fifth secure tunnel, and wherein:
the second partner's second virtual machine instance is in communication with a second partner's first virtual machine instance located on a second partner's private cloud via a fourth secure tunnel; and
the second partner's first virtual machine instance is configured to track the status of a portion of the supply chain for which the second partner is responsible; and
receiving, by the second enterprise virtual machine instance, data regarding the status of the portion of the supply chain for which the second partner is responsible.

17. The method of claim 16, further comprising:
establishing a sixth secure tunnel between the first partner's second virtual machine instance and the second partner's second virtual machine instance; and
receiving, by the first partner's second virtual machine instance and from the second partner's second virtual machine instance, data regarding the status of the portion of the supply chain for which the second partner is responsible.

18. A non-transitory computer-readable medium including computer executable instructions stored thereon, the instructions being effective cause a computer to:
establish a first secure tunnel between an enterprise private cloud and an enterprise public cloud, wherein a first enterprise virtual machine instance located on the enterprise private cloud and a second enterprise virtual machine instance located on the enterprise public cloud are in communication via the first secure tunnel, and wherein the first enterprise virtual machine instance is configured to monitor supply chain partners;
establish a third secure tunnel between the enterprise public cloud and a first partner's public cloud, wherein the second enterprise virtual machine instance located on the enterprise public cloud is in communication with a first partner's second virtual machine instance located on the first partner's public cloud via the third secure tunnel, and wherein:
the first partner's second virtual machine instance is in communication with a first partner's first virtual machine instance located on a first partner's private cloud via a second secure tunnel; and
the first partner's first virtual machine instance is configured to track status of a portion of the supply chain for which the first partner is responsible; and
receive, by the second enterprise virtual machine instance, data regarding the status of the portion of the supply chain for which the first partner is responsible.

19. The non-transitory computer-readable medium of claim 18, wherein the computer executable instructions are further effective cause a computer to:
receive configuration data from a data management hub virtual machine instance that is in communication with the second enterprise virtual machine instance, wherein the creating of the second secure tunnel uses the configuration data.

20. The non-transitory computer-readable medium of claim 18, wherein the computer executable instructions are further effective cause a computer to:
transmit, from the second enterprise virtual machine instance to the first partner's second virtual machine instance, data regarding the status of other portions of the supply chain for which the first partner is not responsible to the first partner's second virtual machine instance.
